(19) United States
(12) Patent Application Publication
(10) Pub. No.: US 2013/0029111 A1
(43) Pub. Date: Jan. 31, 2013

(54) POST-TREATMENT COMPOSITION FOR A DIGITALLY PRINTED IMAGE

(71) Applicants: Manoj K. Bhattacharyya, Palo Alto, CA (US); Hou T. Ng, Campbell, CA (US); Laurie S. Mittelstadt, Belmont, CA (US)

(72) Inventors: Manoj K. Bhattacharyya, Palo Alto, CA (US); Hou T. Ng, Campbell, CA (US); Laurie S. Mittelstadt, Belmont, CA (US)

(21) Appl. No.: 13/194,066

(22) Filed: Jul. 29, 2011

(51) Int. Cl. B32B 3/10; C09D 7/12; G03G 15/02; C09D 153/00

(52) U.S. Cl. 428/195.1; 524/502; 106/287.24; 399/170

(57) ABSTRACT

A post-treatment composition for a digitally printed image includes a non-polar solvent and a non-ionic surfactant. The non-ionic surfactant is present in an amount ranging from about 0.5 wt % to about 20 wt % of a total weight of substrate used to form the digitally printed image. The post-treatment composition renders the digitally printed image deinkable.

### BACKGROUND

The present disclosure relates generally to a post-treatment composition for a digitally printed image.

Recycling processes may be used to regenerate usable cellulose fibers from waste papers. Some recycling processes involve a deinking method, where ink is removed from waste paper pulp. In some cases, the deinking method includes applying deinking chemicals to waste paper, which interact with and remove the inked portions of the paper. Such deinking processes may, in some instances, pose a challenge for the recycling of some digitally inked papers, including liquid electrophotographic printed images. This may be due, at least in part, to chemical interactions between digital inks and the deinking chemicals traditionally used in deinking methods.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic cross-sectional view of an example of a printed article;

FIG. 2 is a schematic view of an example of a liquid electrophotographic (LEP) printing system;

FIG. 3 is a schematic view of another example of a liquid electrophotographic (LEP) printing system;

FIGS. 4A and 4B are schematic representations of handsheets made from non-deinked pulps (FIG. 4A) and deinked pulps (FIG. 4B), where the pulps are from uncoated LEP print media; and

FIGS. 5A and 5B are schematic representations of handsheets made from non-deinked pulps (FIG. 5A) and deinked pulps (FIG. 5B), where the pulps are from LEP print media having an example of the post-treatment coating applied thereon.

### DETAILED DESCRIPTION

Processes for recycling printed waste papers, in some instances, involve converting the waste paper into a pulp, and then contacting the pulp with deinking chemicals. The deinking chemicals interact with the ink, and then separate the ink from the waste paper. This recycling process has suitably been used for waste papers printed using offset inks, but some challenges may exist for separating and removing digital inks (e.g., LEP or other digitally printed inks) from waste papers. For instance, traditional deinking involves removing ink particulates falling within a size range of about 10 microns to about 100 microns. Some challenges with removing digital ink, particularly digital pigment-based inkjet inks or digital dye-based inkjet inks, include finding a solution to aggregate the pigment particles or the dye molecules into a desired size range, and changing the particles/molecules physical properties from being too hydrophilic to more hydrophobic. It has been found that some existing deinking chemicals do not, in some instances, efficiently separate the ink from fibers of a waste paper. It is believed that the challenge(s) is/are due, at least in part, to the material composition and/or properties of the digital ink, which may, in some instances, adversely interact, or not at all, with the deinking chemicals used by the recycling mill. In many cases, the digital ink cannot be separated and removed from the waste paper to an extent required for adequate waste paper recycling.

Without being bound to any theory, it is believed that digital inks may suitably be separated from waste papers by including a coating of the post-treatment composition disclosed herein printed over the applied digital ink. It is believed that the effective agent(s) (i.e., non-ionic surfactant(s)) in the post-treatment composition help the ink layer (referred to herein as the image layer) to break up into smaller particles or to make the particles floatable during flotation. As such, the post-treatment composition renders the applied digital ink deinkable using, for example, conventional alkaline deinking processes that utilize a combination of NaOH, Na₂SiO₃ and oleic acid.

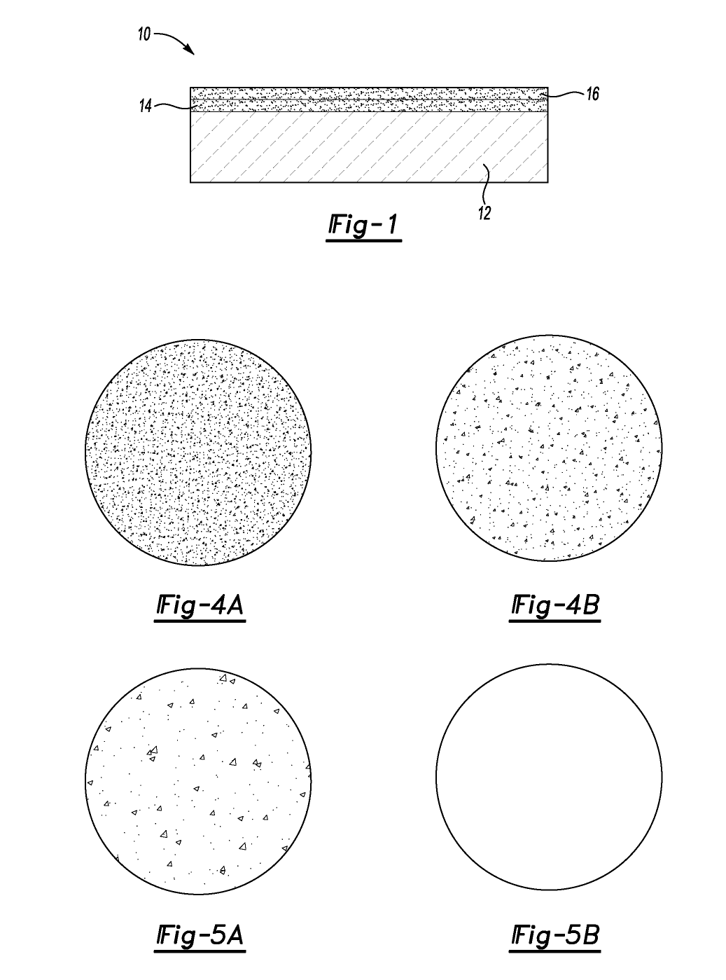

FIG. 1 illustrates a cross-sectional view of an example of the printed article 10 which includes a substrate 12, an image layer 14 applied on all or a portion of the substrate 12, and a post-treatment composition layer 16 applied on the substrate 12 to cover/overlie at least the image layer 14.

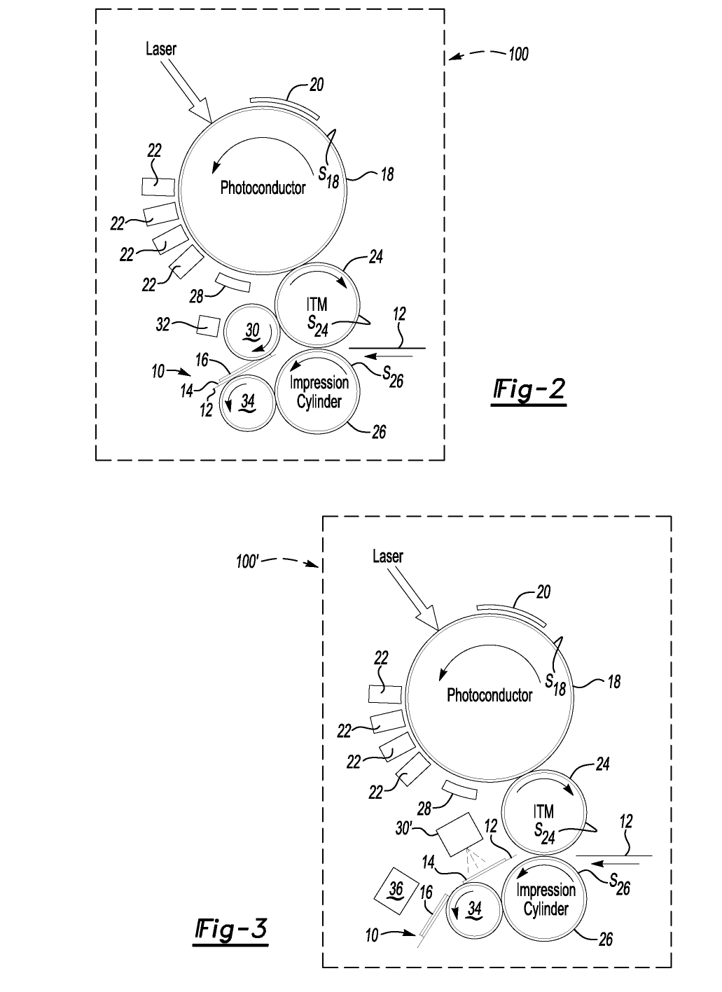

The substrate 12 may take the form of a media sheet or a continuous web suitable for printing via any digital printing system, such as, for example, the printing systems depicted in FIGS. 2 and 3. The substrate 12 may be selected from any porous or non-porous substrate. Examples of porous substrates include coated or uncoated paper. In an example, the substrate 12 may be a base paper manufactured from cellulose fibers. In an example, the base paper may be produced from chemical pulp, mechanical pulp, thermal mechanical pulp, and/or combinations thereof. In some cases, the base paper may also include additives such as internal sizing agents and fillers. The internal agents may be added to the pulp before the pulp is converted into a paper web or medium. The fillers may be any type of filler used in paper such as, e.g., calcium carbonate, talc, clay, kaolin, titanium dioxide, and combinations thereof. The base paper may also be uncoated raw paper, or a pre-coated paper. In an example, the paper has a basis weight ranging from about 60 g/m² (gsm) to about 300 g/m² (gsm). It is believed that some non-porous substrates (e.g., non-cellulose based substrates) may also be recyclable. Some examples of non-porous substrates include elastomeric materials (e.g., polydimethylsiloxane (PDMS)), semi-conductive materials (e.g., indium tin oxide (ITO) coated glass), dielectric materials, flexible materials (e.g., polycarbonate films, polyethylene films, polyimide films, polyester films, and polyacrylate films).

The image layer 14 may be made up of digital ink that is applied to all or a portion of the substrate 12 to form an image. One example of suitable digital inks includes those available from Hewlett Packard under the tradename ELECTROINK®. The digital ink may be a liquid composition, a solid composition, or a composition having a phase that is between a liquid and a solid (e.g., a paste), where any of the inks are printable via any digital printing system, such as an electrophotographic printing system. It is to be understood that the digital ink may be an electrophotographic ink, pigment-based inkjet inks, dye-based inkjet inks, pigment/dye-based inks, dry toners, and/or the like. FIG. 1 illustrates the printed article 10 having an image layer 14 that may be formed using liquid electrophotographic printing. While FIG. 1 illustrates the image layer 14 on top of the substrate 12, it is to be understood that when other printing technologies are utilized (e.g., inkjet), the ink applied to the substrate 12 may penetrate/fuse into the surface of the substrate 12 to form the printed image.

The layer 16 is made up of the post-treatment composition disclosed herein. The post-treatment composition is a solution including a non-polar solvent and a non-ionic surfactant. In an example, the post-treatment composition is an emulsion.

The non-polar solvent makes up the bulk of the post-treatment composition. As such, the amount of non-polar solvent used depends upon the amount of non-ionic surfactant used, and in some instances, the amount of other additives used. In some examples when the non-ionic surfactant alone is used (i.e., no other additives), the composition may include the non-polar solvent in an amount ranging from about 80 wt % to about 99.5 wt % of a total weight of the substrate 12. In other examples when the non-ionic surfactant alone is used (i.e., no other additives), the composition may include the non-polar solvent in an amount ranging from about 97 wt % to about 99.5 wt % of a total weight of the substrate 12.

Examples of suitable non-polar solvents include hydrocarbons, halogenated hydrocarbons, or functionalized hydrocarbons (where functionalization can be accomplished using esters, ethers, sulfonic acids, sulfonic acid esters, and the like). The hydrocarbon may be an aliphatic hydrocarbon, an isomerized aliphatic hydrocarbon, a branched chain aliphatic hydrocarbon, an aromatic hydrocarbon, or combinations thereof. In some examples, the non-polar carrier fluid includes isoparaffinic compounds, paraffinic compounds, dearomatized hydrocarbon compounds, and the like. Specific examples of suitable non-polar carrier fluids include Isopar-G™, Isopar-15 H™, Isopar-L™, Isopar-M™, Isopar-K™, Isopar-V™, Norpar 12®, Norpar 13®, Norpar 15®, Exxsol D40™, Exxsol D80™, Exxsol D100™, Exxsol D130™, and Exxsol D140™ (available from Exxon Mobil Corp.); Teclen N-16™, Teclen N-20™, Teclen N-22™, Nisseki Naphthesol L™, Nisseki Naphthesol M™, Nisseki Naphthesol H™, Solvent L™, Solvent M™, Solvent H™, Nisseki Isosol 300™, Nisseki Isosol 400™, AF-4™, AF-5™, AF-6™ and AF-7™ (available from Nippon Oil Corp.); IP Solvent 1620™ and IP Solvent 2028™ (available from Idemitsu Kosan); and Electron™, Positron™, and New II™ (available from Ecolink).

The non-ionic surfactant may be present in an amount ranging from about 0.5 wt % to about 20 wt % of the total weight of the substrate 12. In some examples, the non-ionic surfactant may be present in an amount ranging from about 0.5 wt % to about 10 wt % of the total weight of the substrate 12. In some other examples, the non-ionic surfactant may be present in an amount ranging from about 0.5 wt % to about 3 wt % of the total weight of the substrate 12. The non-ionic surfactant may be an emulsifier. The non-ionic surfactant may be chosen from polyoxyethylene (12) isooctylphenyl ether ((C₂H₄O)ₙ.C₁₄H₂₂O where n˜12.5, commercially available as, for example, IGEPAL® CA-720); polyoxyethylene (12) nonlyphenyl ether ((C₂H₄O)ₙ.C₁₅H₂₄O where n=10.5-12, commercially available as, for example, IGEPAL® CO-720); polyoxyethylene (2) cetyl ether (C₁₆H₃₃(OCH₂CH₂)₂OH, commercially available as, for example, BRIJ® 52); polyoxyethylene (10) oleoyl ether (C₁₈H₃₅(OCH₂CH₂)₁₀OH, commercially available as, for example, BRIJ® 97); polyoxyethylene (20) oleyl ether (C₁₈H₃₅(OCH₂CH₂)₂₀OH, commercially available as, for example, BRIJ® 98); polyoxyethylene (100) stearyl ether (C₁₈H₃₇(OCH₂CH₂)₁₀₀OH, commercially available as, for example, BRIJ® 700); poly(ethylene glycol) dodecyl ether (C₁₂H₂₅(OCH₂CH₂)₄OH, commercially available as, for example, BRIJ® 30); poly(ethylene glycol) (150) distearate (H₃₅C₁₇CO(OCH₂CH₂)ₙOCC₁₇H₃₅); poly(ethylene glycol) (12) tridecyl ether (mixture of C₁₁ to C₁₄ iso-alkyl ethers with C₁₃ iso-alkyl predominating); poly(ethylene glycol) (18) tridecyl ether (mixture of C₁₁ to C₁₄ iso-alkyl ethers with C₁₃ iso-alkyl predominating); methoxy poly(ethylene glycol) 350 (H₃C(OCH₂CH₂)₁₂OH); polyethylene-block-poly(ethylene glycol) with a number average molecular weight (Mn) ranging from 500 to 2500; a monostearate having the formula CH₃(CH₂)₁₆COO(CH₂CH₂O)ₙH, where n=1-16; a monopalmitate having the formula CH₃(CH₂)₁₄COO(CH₂CH₂O)ₙH, where n=2-17; a distearate having the formula CH₃(CH₂)₁₆COO(CH₂CH₂O)ₙOC(CH₂)₁₆CH₃, where n=5-13; a dipalmitate having the formula CH₃(CH₂)₁₄COO(CH₂CH₂O)ₙOC(CH₂)₁₄CH₃, where n=2-13; a mixed diester having the formula CH₃(CH₂)₁₄COO(CH₂CH₂O)ₙOC(CH₂)₁₆CH₃, where n=2-14; and mixtures thereof. In an example, the non-ionic surfactant has the formula CH₃(CH₂)₁₆COOH₂(CH₂CH₂O)₈H. An example of this non-ionic surfactant is commercially available under the tradename MYRJ® 45 (also known as MYRJ® S8, which is a multi-component non-ionic surfactant with monostearate, monopalmitate, and their diesters as the major constituents).

In an example, the post-treatment composition may be made up of the non-polar carrier fluid and the non-ionic surfactant, without any other components being added thereto. In another example, the post-treatment composition may include other additives, such as those used to control hydrophobic properties of the printed image, those used to control wetting properties of the printed image, or those used to enhance the gloss of the printed image. Any desirable amount of each of these additives may be used, and in an example, any of the additives may be present in an amount ranging from about 0.1 wt % to about 1 wt %. Suitable hydrophobic additives are capable of increasing the hydrophobicity of the image layer 14. Some examples of hydrophobic additives include silicone (e.g., D4, D5), polyisobutylene succinimide, or copolymers of ethylene methacrylate which are soluble in the selected non-polar solvent of the post-treatment composition. Suitable wetting additives are able to increase the wetting properties of the image layer 14. An example of the wetting additive is soy lecithin. Gloss enhancing additives may include gloss enhancing nanoparticles, such as calcium carbonate, kaolinite, or optical brightening agents.

Since the post-treatment composition is applied over the image layer 14, it is desirable that the post-treatment composition be substantially transparent so that the underlying image layer 14 can be seen through the layer 16.

The thickness of the layer 16 ranges from about 10 nm to about 200 nm. In an example, the thickness of the layer 16 is about 20 nm.

The post-treatment composition may be applied on those portions of the substrate 12 where the image layer 14 is applied, or may be applied across the entire surface of the substrate 12. In an example, a liquid electrophotographic printing system may be used to apply the post-treatment composition. Examples of two printing systems 100, 100′ are shown in FIGS. 2 and 3.

The examples of the liquid electrophotographic printing system 100, 100′ shown in FIGS. 2 and 3 include a photoconductor 18 that is configured to rotate in a first direction (as denoted by the left pointing arrow in the photoconductor 18). The photoconductor 18 has a surface S₁₈ that may be exposed to various elements of the system 100 when the photoconductor 18 is rotated.

A corona generator 20 is operatively positioned adjacent to a portion of the surface S₁₈ of the photoconductor 18. The corona generator 20 may be a single wire or an array of wires (i.e., two or more) that are spaced apart by a distance ranging from about 500 μm to about 2 mm. Examples of suitable wire materials include metals, such as platinum, gold, palladium, titanium, alloys, etc. In the examples disclosed herein, the wire(s) of the generator 20 may be positioned parallel to the plane of the surface (e.g., S₁₈) to be exposed to the corona discharge. This is believed to create a relatively uniform discharge field. The wire(s) of the generator 20 may also be positioned 10 mm or less from the surface to be exposed to the corona discharge. It is to be generally understood that the corona generator 20 is capable of generating a relatively high electric field, where such electric fields are used by the digital printing system for image development and formation of the image layer 14. In an example, the electric charge or field of the corona discharge ranges from about 1 kV to about 5 kV when the current applied to the generator 20 ranges from about 1 μA to about 1000 μA. The current may be convective current, which facilitates improved mixing in the image layer 14.

When the system 100 or 100′ is in operation, the corona discharge from corona generator 20 generates a charge on the portion of the photoconductor surface S₁₈ exposed to the discharge. It is to be understood that the photoconductor 18 rotates to develop a substantially uniform layer of charge on the surface S₁₈. The charge may be positive or negative, depending upon the type of corona generator 20 used.

The systems 100, 100′ may also include a laser (labeled “LASER” in FIGS. 2 and 3) that is positioned adjacent to the photoconductor surface S₁₈. Generally, the laser may be positioned such that as the photoconductor 18 rotates in the first direction, some of the areas of the surface S₁₈ exposed to the corona discharge from the generator 20 are exposed to the emission from the laser. The laser may be selected so that its emission can generate charges opposite to those already present on the surface S₁₈ from within the photoconductor 18. By virtue of creating these opposite charges, the laser effectively neutralizes the previously formed charges at areas exposed to the laser emission. This neutralization forms a latent image. It is to be understood that those areas of the surface S₁₈ not exposed to the laser remain charged.

A controller or processor (not shown) operatively connected to the laser commands the laser to form the latent image so that the remaining charged portions of the surface S₁₈ can be used to generate the desirable digital image. The processor is capable of running suitable software routines or programs (non-transitory machine readable instructions embedded on a medium) for receiving desirable digital images, and generating commands to reproduce the digital images using the laser, as well as other components of the systems 100, 100′.

The systems 100 and 100′ may further include at least one ink reservoir/cartridge 22. Each of the ink reservoirs or cartridges 22 is associated with a fluid ejector or printhead (e.g., a thermal printhead or a piezoelectric printhead). Each reservoir/cartridge 22 houses a digital ink. Loading of the digital ink may be accomplished, e.g., by filling the reservoir 22 with the ink, which is operatively connected to the fluid ejector or printhead. The reservoir/cartridge 22 may then be loaded into the printing system 100. It is to be understood that, in an example, the inks are selected to carry a charge that is opposite to that of the uniform layer of charge on the surface S₁₈. The ink reservoir(s)/cartridge(s) 22 are also operatively positioned to deposit the ink(s) onto the remaining charged portion(s) of the surface S₁₈ to form an ink layer (not shown) on the surface S₁₈ of the photoconductor 18. It is to be understood that the charges remaining on the surface S₁₈ after exposure to the laser will attract the oppositely charged ink(s).

Additionally or alternatively, it is to be understood that electrically neutral carrier(s) (i.e., inks without colorants) can be deposited on the discharged (i.e., neutralized) regions or the remaining charged regions of the surface S₁₈, so that a continuous layer 14 is transferred to the substrate 12. Likewise, charged ink can be transferred from cartridge(s) 22 onto the discharged (i.e., neutralized) regions on the surface S₁₈ by applying an appropriate potential bias between the cartridges 22 and the surface S₁₈.

These examples of the system 100, 100′ may also include an intermediate transfer medium (ITM) 24 and an impression cylinder 26. The ITM 24 may be, for example, a dielectric drum, that is configured to rotate in a second direction (denoted by the right pointing arrow), while the IC is configured to rotate in the first direction (i.e., the same direction as the photoconductor 18, denoted by the left pointing arrow) that is opposite to the rotation direction of the ITM 24. The three components 18, 24, 26 operate such that the ink can be transferred from the photoconductor 18 to the ITM 24, and from the ITM 24 to the substrate 12, which is guided by the impression cylinder 26. While not shown, it is to be understood that each of the components are in operative communication with the controller or processor that is capable of running suitable software routines or programs for receiving desirable digital images, and generating commands to reproduce the digital images (e.g., image layer 14) on a substrate 12.

As the photoconductor 18 rotates, the ink is transferred to the surface S₂₄ of the intermediate transfer medium 24. The impression cylinder 26 guides the substrate 12 such that a surface of the substrate 12 contacts the ink on the rotating intermediate transfer medium 24. When in contact, the ink transfers to the substrate 12 (in the presence of an electric field).

The systems 100, 100′ may also include a charge neutralization unit 28 positioned before the intermediate transfer medium 24 and adjacent to the surface S₁₈ of the photoconductor 18. The charge neutralization unit 28 neutralizes any opposite charges remaining on the surface S₁₈ of the photoconductor 18 prior to the next cycle of printing.

Further, the systems 100, 100′ may also include a post-treatment composition applicator 30 (shown in FIG. 2) or 30′ (shown in FIG. 3). Examples of suitable applicators 30, 30′ may include spraying mechanisms, rollers, brushes, air-knife coating mechanisms, blade coating mechanisms, sponges, and combinations thereof

The post-treatment composition applicator 30 shown in FIG. 2 is a roller that receives the post-treatment composition from a dispenser 32. The dispenser 32 may be similar to the cartridge 22, or may be any other dispenser 32 that is capable of depositing the post-treatment fluid on the applicator 30. The roller applicator 30 rotates in the same direction as the ITM 24. Opposite the roller applicator 30 is another roller 34 that rotates in the same direction as the impression cylinder 26. The roller 34 receives the substrate 12 having the image layer 14 (i.e., the ink) printed/applied thereon, and the roller 34 guides the substrate 12 such that the image layer 14 contacts the post-treatment composition that has been dispensed on the roller 30. When in contact, the post-treatment composition transfers to the image layer 14 and the substrate 12 to form the layer 16.

Other examples of the post-treatment composition applicator include the dispenser/reservoir 32, the roller 30, and a metering blade (not shown).

The post-treatment composition applicator 30′ shown in FIG. 3 is a dispenser that contains and deposits the post-treatment composition. The applicator 30′ may be any spraying mechanism capable of depositing the post-treatment fluid directly on the image layer 14 and the substrate 12. The roller 34 (that rotates in the same direction as the impression cylinder 26) guides the substrate 12 such that the image layer 14 is positioned to have the post-treatment composition applied thereto. When the substrate 12 (and layer 14 thereon) is moved in proximity of the applicator 30′, the post-treatment composition is dispensed on the image layer 14 and the substrate 12 to form the layer 16.

It is to be understood that the systems 100, 100′ disclosed herein may be set up to perform two-sided printing, where the post-treatment composition may be applied to both sides of a substrate 12.

The example system 100′ shown in FIG. 3 also includes a heating mechanism 36. The heating mechanism 36 is positioned to heat the post-treatment composition after it has been applied to the substrate 12 and layer 14.

The heating mechanism 36 operates to speed up the drying of the post-treatment composition layer 16. Heating may be accomplished using hot air, infrared heating, etc. Any suitable heating mechanism 36 may be used, including a hot air dryer and/or an infrared lamp. The time for drying should be compatible with the speed of the printer, so that the printing time is not lengthened.

While not shown, it is to be understood that the system 100 may also include a heating mechanism 36.

It is to be further understood that active drying may also be eliminated. For example, when the non-ionic surfactant loading in the post-treatment composition is relatively high (e.g., greater than 5 wt %) and the applied loading is relatively low (e.g., final thickness of the layer 16 is less than 20 nm), active drying may not be used.

As mentioned herein, the post-treatment composition renders the printed image deinkable. Fibers of the substrate 12 upon which the image layer 14 and post-treatment composition layer 16 are directly deposited to form the printed article 10 may be recycled using a conventional paper recycling process. For example, the printed medium 12 (having the ink/image layer 14 and the post-treatment composition layer 16 thereon) may be placed inside a recycling mill, and then the colorant of the ink 14 deposited on the substrate 12 may be detached from the fibers of the substrate 12 to form a deinked pulp. The detaching of the colorant from the substrate 12 may be referred to herein as a deinking process. This deinking process includes introducing the printed article 10 into a pulper of the recycling mill, and then chopping the printed article 10 up into smaller pieces. In an alkaline-based process, pulping takes place in the presence of alkaline-based deinking chemicals, such as NaOH, a Na₂SiO₃ solution, Oleic Acid, and H₂O₂. In this deinking process, the non-ionic surfactant in the post-treatment composition may act as a dispersant to prevent the dislodged and disintegrated ink specks from aggregating together (in the case of LEP), or as a collector to aggregate submicron-sized pigments and molecular-sized dyes into large ink specks suitable for froth flotation.

It is to be understood that during the alkaline-based deinking processes, water may be added inside the pulper while the medium is chopped, thereby converting the printed article 10 into a slurry of pulp and ink.

Upon making the slurry, a flotation process is performed, which separates the ink from the slurry. When an alkaline-based deinking process is used, the slurry is introduced into a froth flotation cell. The flotation process of this example may take place in the presence or the absence of a frother. One example of a suitable frother is sodium dodecyl sulfate. The frother facilitates formation of foam which allows the removal of the detached ink particles from the fibers. More particularly, since the frother has an affinity to the now-detached colorant particles, the colorant particles attach to the frother foam. In an example, air is also blown into the slurry. The air bubbles lift the colorant particles to the surface of the flotation cell as a thick froth, which may be removed from the cell.

In some instances, the pulp slurry is screened to remove any materials that may be denser than the pulp, such as contaminants or other foreign matter. In an example, coarse and fine screening may be accomplished by passing the slurry over or through a screen with varying slot opening sizes to separate such materials from the slurry, and these materials may be caught using another mesh screen.

To further illustrate the present disclosure, an example is given herein. It is to be understood that this example is provided for illustrative purposes and is not to be construed as limiting the scope of the disclosed example(s).

### EXAMPLE

An example of the post-treatment composition was prepared using ISOPAR® L and MYRJ® 45. The composition was a 2% solution of the MYRJ® 45 in the ISOPAR® L. Photos were generated using an HP Indigo 7000 digital press. In particular, ELECTROINK® 4.5 was printed on M-Real Silver Digital Gloss paper (130 gsm). After the images were printed, the post-treatment composition was sprayed on the imaged side of the paper via a pressurized air gun. After the post-treatment composition was sprayed, there was no noticeable paper distortion. Post-treatment composition application was followed by immediate drying using a hot air gun.

For comparative examples, the post-treatment composition was not applied after the ELECTROINK® was printed on M-Real Silver Digital Gloss paper.

An alkaline-based deinking evaluation was performed for the coated LEP print media samples and the comparative uncoated LEP print media samples. The alkaline-based deinking followed the protocol as outlined in INGEDE (International Association of the Deinking Industry) Method 11. The first step of the alkaline-based deinking process involved pulping some of the printed papers in the presence of 0.6% NaOH, 1.8% Na₂SiO₃ solution, and 0.8% Oleic Acid (no hydrogen peroxide was used). Pulping with 15% consistency at 45° C. occurred for about 20 minutes. This was then followed by a flotation process (about 1% consistency, 45° C., about 20 minutes) in a flotation cell.

Pulp samples were retrieved throughout the process, and respective handsheets were made from all of the pulps (those obtained before and after flotation) to evaluate the efficiency of the deinking processes when the post-treatment composition disclosed herein was utilized as an overcoat. The sample pulps obtained before flotation are referred to herein as undeinked samples and the sample pulps obtained after flotation are referred to herein as deinked samples.

Table 1 shows the results for the deinked uncoated and coated LEP samples. The first section of Table 1 illustrates the European Recycling Paper Council's deinking score card parameters; the second section of Table 1 illustrates the scores for the coated LEP samples; and the third section of Table 1 illustrates the scores for the uncoated LEP samples.

TABLE 1

| | | | | | | |
|---|---|---|---|---|---|---|
| | Color | | | Ink | Filtrate | |
| Optical | Shade, | Dirt, A₅₀ | Dirt, A₂₅₀ | Elimination, | Darkening, | Total |
| Brightness, Y | a* | (mm²/m²) | (mm²/m²) | IE (%) | ΔY | Score |

European Recycling Paper Council Deinking Scorecard's Parameters

| | | | | | | | |
|---|---|---|---|---|---|---|---|
| Threshold | 47 | −3/+2 | 2000 | 600 | 40 | 18 | 100 |
| Target | 90 | −2/+1 | 600 | 180 | 80 | 6 | |
| Max | 35 | 20 | 15 | 10 | 10 | 10 | |
| Score | | | | | | | |

Coated LEP Samples

| | | | | | | | |
|---|---|---|---|---|---|---|---|
| Result | 87.2 | −1.1 | 508 | 106 | 93.3 | 4.4 | 98 |
| Score | 33 | 20 | 15 | 10 | 10 | 10 | |

Comparative Uncoated LEP Samples

| | | | | | | | |
|---|---|---|---|---|---|---|---|
| Result | 87.2 | −1.08 | 15900 | 11700 | 90 | 3 | negative |
| Score | 33 | −30 | negative | negative | 10 | 10 | |

FIGS. 4A, 4B, 5A and 5B show schematic view of the handsheets made from the undeinked pulps (i.e., those that did not undergo flotation) and deinked pulps of the uncoated LEP print media samples (FIGS. 4A and 4B) and the coated LEP print media samples (FIGS. 5A and 5B). More particularly, FIGS. 4A and 4B show schematic illustrations of the handsheets made, respectively, from the undeinked and deinked pulps of the uncoated LEP print media samples that were obtained via the alkaline-based process; and FIGS. 5A and 5B show schematic illustrations of the handsheets made, respectively, from the undeinked and deinked pulps of the coated LEP print media samples that were obtained via the alkaline-based process.

It is to be understood that a total score of 70 on the European Recycling Paper Council's deinking score card is considered to be good deinkability.

The results obtained for the comparative uncoated LEP samples illustrate the poor deinkability of LEP images when the post-treatment composition disclosed herein is not used. While the optical brightness, color shade, ink elimination, and filtrate darkening results were acceptable, the dirt particle results were negative. This is indicative of undesirable ink speck sizes, and thus the overall score for the comparative uncoated LEP sample was negative.

In contrast, the results obtained for the coated LEP samples illustrated that the coating facilitated good deinkability of LEP inks from the media. The optical brightness (luminosity) of the coated LEP print media samples was close to the target level (for high-grade writing paper) of 90%. The filtrate darkening (i.e., an indication of the discoloration of the deinking process water) was 4.4, which was noticeably better than the target level of 6. The color shade was also well within the target range. The dirt particle results were also below the target level, which is desirable. The ink elimination of the deinked coated LEP pulps is well beyond the threshold. The results for the handsheets formed from the undeinked and deinked pulps of the coated LEP samples illustrate that the coating renders the media deinkable and effectively enhances deinking.

It is to be understood that the ranges provided herein include the stated range and any value or sub-range within the stated range. For example, a range from about 0.1 wt % to about 30 wt % should be interpreted to include not only the explicitly recited limits of about 0.1 wt % to about 30 wt %, but also to include individual values, such as 0.2 wt %, 5 wt %, 12 wt %, etc., and sub-ranges, such as from about 0.5 wt % to about 10 wt %, from about 3 wt % to about 20 wt %, etc. Furthermore, when “about” is utilized to describe a value, this is meant to encompass minor variations (up to +/−10%) from the stated value.

Still further, it is to be understood use of the words “a” and “an” and other singular referents include plural as well, both in the specification and claims

While several examples have been described in detail, it will be apparent to those skilled in the art that the disclosed examples may be modified. Therefore, the foregoing description is to be considered non-limiting.

What is claimed is:

1. A post-treatment composition for a digitally printed image, comprising:
a non-polar solvent; and
a non-ionic surfactant present in an amount ranging from about 0.5 wt % to about 20 wt % of a total weight of a substrate used to form the digitally printed image;
wherein the post-treatment composition renders the digitally printed image deinkable.

2. The post-treatment composition as defined in claim 1 wherein the non-ionic surfactant is chosen from polyoxyethylene (12) isooctylphenyl ether; polyoxyethylene (12) nonlyphenyl ether; polyoxyethylene (2) cetyl ether; polyoxyethylene (10) oleoyl ether; polyoxyethylene (20) oleyl ether; polyoxyethylene (100) stearyl ether; poly(ethylene glycol) dodecyl ether; poly(ethylene glycol) (150) distearate; poly(ethylene glycol) (12) tridecyl ether; poly(ethylene glycol) (18) tridecyl ether; methoxy poly(ethylene glycol) 350; polyethylene-block-poly(ethylene glycol) with a number average molecular weight ranging from 500 to 2500; a monostearate having a formula CH₃(CH₂)₁₆COO(CH₂CH₂O)ₙH, wherein n=1-16; a monopalmitate having a formula CH₃(CH₂)₁₄COO(CH₂CH₂O)ₙH, wherein n=2-17; a distearate having a formula CH₃(CH₂)₁₆COO(CH₂CH₂O)ₙOC(CH₂)₁₆CH₃, wherein n=5-13; a dipalmitate having a formula CH₃(CH₂)₁₄COO(CH₂CH₂O)ₙOC(CH₂)₁₄CH₃, wherein n=2-13; a mixed diester having a formula CH₃(CH₂)₁₄COO(CH₂CH₂O)ₙOC(CH₂)₁₆CH₃, wherein n=2-14; and mixtures thereof.

3. The post-treatment composition as defined in claim 2 wherein the monostearate selected as the non-ionic surfactant has the formula CH₃(CH₂)₁₆COOH₂(CH₂CH₂O)₈H.

4. The post-treatment composition as defined in claim 1, further comprising any of additives to control hydrophobic properties of the digitally printed image, additives to control wetting properties of the digitally printed image, or gloss enhancing nanoparticles.

5. The post-treatment composition as defined in claim 1 wherein the composition is transparent.

6. The post-treatment composition as defined in claim 1 wherein the composition consists of the non-polar solvent and the non-ionic surfactant.

7. The post-treatment composition as defined in claim 1 wherein the post-treatment composition is for a liquid electrophotographic (LEP) printed image.

8. A liquid electrophotographic printing system, comprising:
a photoconductor to rotate in a first direction and including a surface;
a corona generator positioned adjacent to the photoconductor surface to expose the photoconductor surface to corona discharge to form a uniform layer of charge thereon;
a laser positioned adjacent to the photoconductor surface to neutralize a portion of the uniform layer of charge on the photoconductor surface to form a latent image;
at least one ejector positioned to eject a printing composition on a remaining charged portion of the uniform layer of charge to form an ink layer on the photoconductor surface;
an intermediate transfer medium positioned to receive the ink layer from the photoconductor;
an impression cylinder rotatable in the first direction to guide a substrate such that a surface of the substrate contacts the intermediate transfer system and receives the ink layer from the intermediate transfer medium; and
a post-treatment composition applicator to contain a post-treatment composition and positioned to dispense the post-treatment composition on the ink layer on the substrate, the post-treatment composition including:
a non-polar solvent; and
a non-ionic surfactant present in an amount ranging from about 0.5 wt % to about 3 wt % of a weight of a substrate used to form the LEP printed image, the non-ionic surfactant being chosen from polyoxyethylene (12) isooctylphenyl ether; polyoxyethylene (12) nonlyphenyl ether; polyoxyethylene (2) cetyl ether; polyoxyethylene (10) oleoyl ether; polyoxyethylene (20) oleyl ether; polyoxyethylene (100) stearyl ether; poly(ethylene glycol) dodecyl ether; poly(ethylene glycol) (150) distearate; poly(ethylene glycol) (12) tridecyl ether; poly(ethylene glycol) (18) tridecyl ether; methoxy poly(ethylene glycol) 350; polyethylene-block-poly(ethylene glycol) with a number average molecular weight ranging from 500 to 2500; a monostearate having a formula CH₃(CH₂)₁₆COO(CH₂CH₂O)ₙH, wherein n=1-16; a monopalmitate having a formula CH₃(CH₂)₁₄COO(CH₂CH₂O)ₙH, wherein n=2-17; a distearate having a formula CH₃(CH₂)₁₆COO(CH₂CH₂O)ₙOC(CH₂)₁₆CH₃, wherein n=5-13; a dipalmitate having a formula CH₃(CH₂)₁₄COO(CH₂CH₂O)ₙOC(CH₂)₁₄CH₃, wherein n=2-13; a mixed diester having a formula CH₃(CH₂)₁₄COO(CH₂CH₂O)ₙOC(CH₂)₁₆CH₃, wherein n=2-14; and mixtures thereof.

9. The printing system as defined in claim 8 wherein the post-treatment composition applicator contains the post-treatment composition therein.

10. The printing system as defined in claim 8, further comprising a dryer positioned to dry the post-treatment composition on the ink layer on the substrate.

11. The printing system as defined in claim 8 wherein the post-treatment applicator is chosen from a sprayer, a roller, a brush, an air-knife coater, a blade coater, a sponge, and combinations thereof.

12. A printed article, comprising:
a substrate having an image applied thereon; and
a layer of a post-treatment composition applied to the substrate at least overlying the image, the post-treatment composition including:
a non-polar solvent; and
a non-ionic surfactant present in an amount ranging from about 0.5 wt % to about 20 wt % of a weight of the substrate, the non-ionic surfactant being chosen from polyoxyethylene (12) isooctylphenyl ether; polyoxyethylene (12) nonlyphenyl ether; polyoxyethylene (2) cetyl ether; polyoxyethylene (10) oleoyl ether; polyoxyethylene (20) oleyl ether; polyoxyethylene (100) stearyl ether; poly(ethylene glycol) dodecyl ether; poly(ethylene glycol) (150) distearate; poly(ethylene glycol) (12) tridecyl ether; poly(ethylene glycol) (18) tridecyl ether; methoxy poly(ethylene glycol) 350; polyethylene-block-poly(ethylene glycol) with a number average molecular weight ranging from 500 to 2500; a monostearate having a formula CH₃(CH₂)₁₆COO(CH₂CH₂O)ₙH, wherein n=1-16; a monopalmitate having a formula CH₃(CH₂)₁₄COO(CH₂CH₂O)ₙH, wherein n=2-17; a distearate having a formula CH₃(CH₂)₁₆COO(CH₂CH₂O)ₙOC(CH₂)₁₆CH₃, wherein n=5-13; a dipalmitate having a formula CH₃(CH₂)₁₄COO(CH₂CH₂O)ₙOC(CH₂)₁₄CH₃, wherein n=2-13; a mixed diester having a formula CH₃(CH₂)₁₄COO(CH₂CH₂O)ₙOC(CH₂)₁₆CH₃, wherein n=2-14; and mixtures thereof;
wherein the layer of the post-treatment composition renders the printed article deinkable.

13. The printed article as defined in claim 12 wherein the layer of the post-treatment composition has a thickness ranging from about 10 nm to about 200 nm.

14. The printed article as defined in claim 12 wherein the post-treatment composition further includes any of additives to control wetting properties of the printed image, additives to control wetting properties of the printed image, or gloss enhancing nanoparticles.

15. The printed article as defined in claim 12 wherein the layer of the post-treatment composition is transparent.

16. The printed article as defined in claim 12 wherein the monostearate selected as the non-ionic surfactant has the formula CH₃(CH₂)₁₆COOH₂(CH₂CH₂O)₈H.

17. A method of generating the printed article of claim 12, the method comprising:
applying the image on the substrate using a liquid electrophotographic printer;
applying the post-treatment composition on the image; and
drying the post-treatment composition to form the layer.
